(19) United States
(12) Patent Application Publication
(10) Pub. No.: US 2006/0229486 A1
(43) Pub. Date: Oct. 12, 2006

(54) Disposal area for storing substances composite substances or mixtures thereof, method for treating the same, and corresponding device

(76) Inventor: Christoph Muther, Hergiswil (CH)

Correspondence Address: BACHMAN & LAPOINTE, P.C., 900 CHAPEL STREET, SUITE 1201, NEW HAVEN, CT, 06510, US

(21) Appl. No.: 10/567,767

(22) PCT Filed: Aug. 10, 2004
(86) PCT No.: PCT/EP04/08948

§ 371 Date: Feb. 10, 2006

(30) Foreign Application Priority Data
Aug. 13, 2003 (DE) 103 37 375.6

(51) Int. Cl. B09B 1/00

(52) U.S. Cl. 588/257; 405/129.2; 241/27

(57) ABSTRACT

In a waste disposal site for storing waste and residues of solid organic or inorganic substances, composites and mixtures thereof, arranged in the ground (22) is a trough comprising a trough bottom (14) and side walls, the trough bottom of which contains at least two water-tight layers (B, C) with constituents of a ceramic binder system (CBS). Arranged flat between the top water-tight layer (C) and the waste material (24a) is at least one water-tight plastic film (26) on which compacted debris is stored as waste material (24a). Moreover, there is a covering which contains at least two water-tight layers (B, C) on which there is arranged at least one seepage layer for dissipating rainwater.

### BACKGROUND OF THE INVENTION

The invention relates to a waste disposal site for storing waste and residues of solid organic and inorganic substances or mixtures thereof and to an apparatus for this purpose.

The abovementioned waste includes for example industrial residues such as slag from the metallurgical industry, but also domestic waste of varying composition. The latter mainly comprises organic mixtures such as foodstuffs, plastic packaging, composite packaging, but also inorganic constituents such as glass, metals and composites thereof.

These mixtures and composites pose problems in particular in terms of disposal since for a long time separation of the mixtures and of the substances in the composite has not taken place or has taken place only to an unsatisfactory extent at a high cost in terms of energy. Most of this waste is incinerated or dumped. Only waste with a small amount of impurities—for example cans made of aluminium sheet—are subject to material use. More complex waste cannot be treated for the purpose of material use on account of the lack of technical possibilities or on account of the high costs due for example to wet-chemical processes or thermal processes.

In the case of conventional mechanical treatment, the breakdown of the composite element takes place by way of the grain or particle size, which is smaller than the respective layer thickness of the components. This breaking-down is usually carried out by means of an at least one-stage small-grain comminution in corresponding mills—for instance hammer mills, impact crushers or countercurrent mills—possibly aided by nitrogen for inerting the intense cooling.

WO-A-9 305 883 contains a method flowchart for recovering fibres from glass-fibre-reinforced plastics or the like by means of a shredder, following which the comminuted material is pulverized. Released fibres are separated from this powder and the remaining pulverized debris is used for example as a filler. In this flowchart there is a micromill which is referred to as a pulveriser.

In a method according to WO 95/25595 for treating composite elements of solid organic and/or inorganic composite materials such as metal/metal composites, plastic/plastic composites, metal/plastic composites or mineral composites with metals and/or plastics, a mixture is fed to the breakdown edges at a rate of 20 to 60 m/sec² and a movement which breaks down the mixture in an acceleratory manner is produced in the swirls. Moreover, during this separation or breakdown operation, the adhesion between the components of the solid parts is increased by virtue of the acceleration and friction forces which exceed the force of said adhesion, and the components of the solid parts are detached from or drawn off one another to separate the layers of said composite material.

The object of the known methods is thus to separate, comminute, homogenize and also partially or completely break down composites and substance mixtures. Such methods are based in particular on mechanical shearing and crushing, on relatively uncontrolled breakdown or on separation in high-energy swirls.

### SUMMARY OF THE INVENTION

Knowing these conditions, the inventor set himself the aim of providing a sanitation concept for waste disposal sites—including those that already exist—which also includes a transfer of the waste bodies in order to make room for another use—e.g. for urban development. Moreover, a method is to be developed which can be used to treat and dispose of mixtures and composite elements, in particular domestic waste.

According to the invention, in order to create the waste disposal site, arranged in the ground is a trough comprising a trough bottom and side walls, the trough bottom of which contains at least two—preferably three—water-tight layers with constituents of a ceramic binder system (CBS), the composition of which will be explained below. In this case, it has proven advantageous to arrange at least one water-tight plastic film flat between the top water-tight layer and the deposited waste material, wherein above all compacted debris is to be stored as waste material.

According to another feature of the invention, side walls project from the trough bottom inclined at an angle of 90° to 150°, preferably about 130°. Moreover, the trough bottom is to be inclined at an angle of less than 10° with respect to the horizontal, in order to assist the dissipation of water.

It has proven advantageous to provide a covering on the waste disposal site, which covering contains at least two water-tight layers, wherein on the latter there is arranged at least one seepage layer for dissipating rainwater. This seepage layer is moreover provided with drainage. This seepage layer is furthermore superposed by a humus layer which possibly bears a thin slurry layer as erosion protection.

According to the invention, in order to sanitize and transfer the waste bodies, the stored material is to be subjected to an intermediate treatment. Here, valuable substances are removed from the waste and recycled into industrial cycles as secondary raw materials. Compacting measures additionally help to considerably reduce the volume that is to be disposed of.

Prior to being disposed of, the daily amounts of domestic waste are to be fed to a separating plant which as far as possible allows recycling of the materials, wherein, besides secondary raw materials, also water and compost are obtained. By virtue of this measure, the volume of waste to be disposed of can be drastically reduced.

Within the context of the invention, an existing waste body is brought to a new waste disposal site that is to be established at another location. The new waste disposal site must receive both the existing waste material and also the existing covering and the substructure of the old waste disposal site.

The waste taken from the old waste disposal site is subjected to an intermediate treatment, on the one hand to reduce the volume of waste that is to be disposed of and on the other hand also to allow a separation of valuable substances. This intermediate treatment corresponds to the method described below analogously to the separation of the daily new waste. It is assumed that in future the new waste disposal site will have to be designed only for one class (type of waste disposal site: inert substances waste disposal site).

In a plan by stages, the waste disposal site that is to be newly built, which will have a segmented structure, is expanded in steps. The expected volume of the waste disposal site will decrease in absolute terms and also in terms of percentage over the time axis since the intermediate treatment of the waste material will be started sequentially for technical reasons and also in accordance with capacity. It is to be assumed that once the plant is finished there will be a reduction by more than 95% of the volume that is to be disposed of.

The conceptional procedure for sanitizing the waste disposal site and recultivating is configured as follows: Firstly the volume of the waste disposal site is determined and an analysis of the waste material and evaluation of the latter is carried out. The location of the new waste disposal site is then determined, as is the intermediate treatment site. Next comes the planning and designing of the new waste disposal site, logistic planning, etc. with regard to approval for constructing and operating the intended site and planning and designing the intermediate treatment sites. Following the approval procedure for the waste disposal site and the intermediate treatment site, the first stage of the new waste disposal site is built and the first intermediate treatment stage is set up for the old waste material, then the sanitation of the old waste disposal site is begun with the waste being transported away, subjected to an intermediate treatment and placed in the new waste disposal site. The site of the old waste disposal site is then recultivated according to the requirements of future use, and the intermediate treatment site is dismantled, including the step-wise removal of capacity. The procedure ends with the end of relocation and sanitation of the site of the old waste disposal site by means of recultivation measures.

The use of a ceramic binder system CBS in the form of so-called CBS Consolid to stabilize the soil and immobilize the waste and also for sealing purposes is important to the invention. The binder system CBS is an inorganic binder for hydraulic setting compounds in which substances containing silica, alumina, iron oxide and lime are mixed, ground and burned until they are sintered. Domestic waste is comminuted beforehand, homogenized and mixed with calcium-containing additives, such as dolomite, calcite, marl, in particular marl lime or suchlike substances, and also with additives containing aluminium oxide—corundum abrasive chips, clay marl, clinker—and incinerated. Prior to grinding, up to 40% by weight—preferably somewhat more than 10% by weight—of tectosilicates are added to the product obtained after incineration, and the resulting product is ground to a very small particle size.

This binder system advantageously comprises a liquid phase and a solid phase, the latter consisting of very fine-grained hydraulic binder and calcium hydroxide and also up to 10%—preferably about 4%—of organic component; the liquid phase should be a mixture of monomolecular and polymolecular surface-active substances, solubilizers, emulsifiers and catalysts having a content of propylenediamine, dimenthyl ammonium chloride and isopropyl alcohol. An irreversible agglomeration of the fine and very fine particles of the treated layer is produced by means of the ceramic binder system, with a high degree of compacting of the bottom fraction associated with the binder system. The waste or other such substances stored in the interior of the waste disposal site should be bound by adding mineral components, in particular by means of said ceramic binder (CBS).

Compared to conventional stabilizing systems, CBS Consolid is characterized by a considerable improvement in the properties of the soil. The bearing capacity is increased three-fold to five-fold. By virtue of the sealing against any water penetrating in, the frost resistance is considerably increased. Potential harmful substances can likewise no longer leach out. The soil treatment can be carried out in a relatively simple manner and does not entail any time restriction during set-up. The soil improvement is permanent and increases over time; a positive long-term effect is thus obtained. By using soil present on site, the costs can be considerably reduced and a saving can likewise be made in that there is no need to buy expensive mineral raw materials. The same also applies in respect of all the other materials to be bound, which can be compacted by the CBS Consolid system.

The basic mode of action of the Consolid system is that of a natural organic polymer which binds to the surface of the clay minerals, alters the properties of these clay minerals and allows the formation of stable aggregates.

The concept described here for sanitizing the waste disposal site and separating waste is characterized by its sustainability, by being as kind as possible to the environment and natural resources and also by an extremely favourable cost structure. The separating plant for domestic waste which is shown allows further use of water, compost, biogas, metals and plastics, and also the production of electrical energy. By means of a special method, the mineral constituents can be used as a ceramic binder CBS in the construction industry. Only less than 5% of the domestic waste has ultimately to be disposed of. This all contributes to a high reduction in costs. By means of the so-called Consolid method, waste disposal sites can be sealed for the long term so that the finished waste disposal site can be used in some other way and no more sanitation operations are required.

The invention relates to a method of the type mentioned above, by means of which the waste—in particular domestic waste—is dewatered, separated from contained biomass and then a separation of metal/plastics takes place, these being recycled into industrial cycles as secondary raw materials. Prior to introducing the waste into the waste disposal site, said waste should be bound by adding mineral components and its intrinsic binding forces should be activated and also harmful substances in the waste should be immobilized.

A separation of residues has proven favourable, following which separated-out mineral substances and/or specially fed-in slag or ashes are processed to form a ceramic binder. During this method, main fractions are produced in the form of:
water;
biomass/compost/biogas;
metals such as Al, Fe, Cu metals or the like;
residual waste fractions;
residues.

Mineral substances from the residual waste fraction and/or from the residues and/or from the ultimately produced ash can be used as raw material to produce said binder (CBS). Slag should be sieved off and mixed with slag sand and/or power station ash and/or tectosilicates during a comminution operation.

The plant according to the invention is based on the principle of so-called recycling. Materials are produced in a grade required by industry at competitive costs and in an environmentally friendly manner. The burden on the environment is on the one hand relieved by the reduction in the amount of waste that has to be disposed of or incinerated, and on the other hand the sources of natural raw materials are looked after by recycling to industry the raw materials obtained.

The invention also relates to the fact that the mixtures and composites are split and separated by means of a mechanical method, in which the sending of pulses is used which suddenly stops a transported particle. In the composite or mixture the constituents are broken down or separated by means of a pulse using a device which suddenly interrupts the flow of said composite or mixture; shockwaves occur in or between the layers of the composite elements, said shockwaves breaking down these composite elements. For this purpose, it has proven advantageous if process air is fed in, in a rising flow path, in the opposite direction to the conveying path generated downwards in a spiral-like manner in a rotor with a vertical axis; the abovementioned shockwave is preferably generated on an impact wall of the rotor between the layers of the composite.

According to a further feature of the invention, two wall surfaces arranged coaxially and at a radial distance to one another rotate relative to one another about their axis and the composites or mixtures moved by centrifugal forces are moved and broken down between impact surfaces projecting from the impact walls. The composite may be broken down when it collides with an impact wall and its metal constituents are shaped into spheres; preferably, the layered metal constituent is rolled up during the shaping operation.

It has proven advantageous if the composite element is comminuted to a particle size of 10 mm to 50 mm prior to the splitting or breakdown operation, and possibly also subjected to a heat treatment. Moreover, the discharge from the splitting or breakdown operation may advantageously be subjected to a separation and/or sieving operation and/or to a cracking-off operation for non-iron metals.

According to a further feature of the invention, the separation is carried out on separating tables and/or by means of fluidized bed separators, wherein the metal and/or plastic parts are compacted following separation. For this purpose, it is advantageous to separate the plastics from one another by turbolaminar separation and identification and/or to extrude the metal and/or plastic fractions following separation.

Based on inherent material properties—such as density, modulus of elasticity (=rigidity=resistance to deformation), strength and molecular constellation—shockwaves produced according to the invention propagate within the materials differently in terms of propagation speed, frequency and amplitude. If the forces generated by these shockwaves when they strike the particles exceed the adhesion force of the interfaces—the contact surfaces between the individual material phases—the microshearing that occurs leads to detachment or separation. This principle is aimed at and intentionally used by the invention.

The typical flow behaviour upon exceeding the elastic expansion, e.g. in the case of metals, and respectively the inherent elasticity of e.g. plastics, result in permanent spherical deformations or in—partial—return to the original particle shape (resilience). By virtue of this phenomenon, the phase-separated elements of composite materials can be sorted relatively easily by means of known and established technologies—e.g. on a mechanical, hydraulic or pneumatic basis.

The described method is characterized by the simplicity and functionality of the apparatus according to the invention, and it allows correspondingly simpler or relatively unproblematic operation. The desired simplicity of the concept and design of the described rotor machine allows it to be technically implemented without any problems. The use of material science knowledge, of heat treatment methods, of computer- and simulation-aided design optimization and the possible adaptation and optimization of the process parameters will further increase the expected actual efficiency.

The invention relates to an apparatus for carrying out the described method, in which the conveying path for the composites or the mixture is fed into the interior of a rotor in the opposite direction to that of the flow path of process air, and the material supply is arranged in the ridge region of the rotor. The conveying path should run between two wall surfaces that can be moved relative to and at a distance from one another, from which wall surfaces impact surfaces that are offset with respect to one another project on either side into the conveying path.

According to further features according to the invention, the wall surfaces are coaxially curved and/or are mounted such that they can rotate in the rotation direction of the rotor.

On account of the simplicity of the core process, the separator and the high throughput that can be seen, the resulting separating costs should actually turn out to the relatively low. The corresponding costs ultimately represent the total use of resources such as transport efficiency, energy, operating efficiency (still associated with the use of resources!), consumption of water, air and land, substitution effect or the like and accordingly the overall effect on the environment. If the amount of successfully treated waste flows and conversion thereof into material flows increases on account of the economic attractiveness of the process, this of course results in a corresponding reduction in the consumption of primary resources on account of the resulting substitution.

### BRIEF DESCRIPTION OF THE DRAWINGS

Further advantages, features and details of the invention emerge from the following description of preferred examples of embodiments and with reference to the drawing, in which:

FIG. 1: schematically shows an oblique view of a model of a waste disposal site according to the invention;

FIGS. 2, 3: respectively show an enlarged part-section through the soil region of the waste disposal site and the covering thereof;

FIG. 4 to FIG. 6: show diagrams of the method relating to
dewatering;
separation of biomass;
separation of metals/plastics;

FIGS. 7, 8: show two method flowcharts relating to the separation of residues;

FIG. 9: shows a method flowchart relating to the production of a ceramic binder system;

FIG. 10: schematically shows part of the method when a composite element strikes an impact wall, in three steps;

FIG. 11: shows the change in the composite element fed to the impact wall, in three stages, and

FIG. 12: shows the fourth stage of the composite element;

FIG. 13: schematically shows a plan view of rotating impact surfaces during the method;

FIG. 14: schematically shows a side view of a rotor.

### DETAILED DESCRIPTION

As shown in FIG. 1, a waste disposal site 10 has a seal against earth 22 carrying groundwater, said seal being designed as a trough 12—with side walls 15 inclined outwards at an angle w of about 130° from the trough bottom 14. The interior 18 of this trough 14 is filled with waste material 24—which is covered over by a covering 20 that lies flush with a trough edge 16.

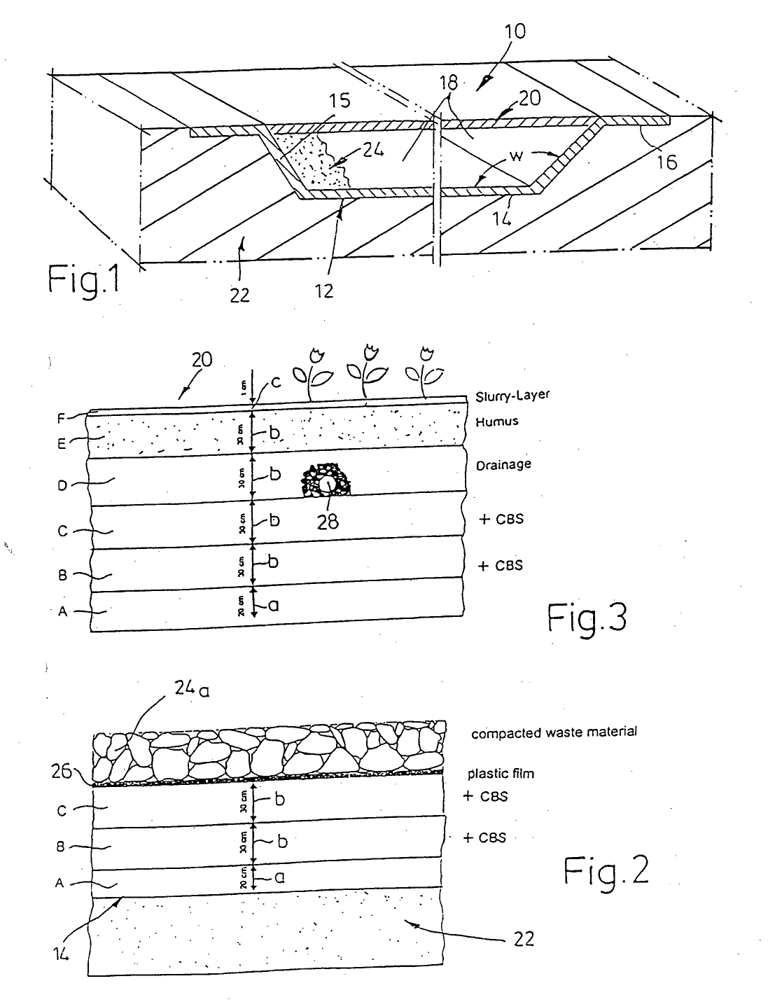

As shown in FIG. 2, the seal against liquids which could possibly emerge from the waste material 24 towards the bottom is provided by a water-impermeable plastic film 26 which runs below a layer of compacted waste material 24a. The substructure of the trough 12 is produced from water-tight layers A, B and C—said water-tightness resulting from the addition of additives—the thicknesses a (layer A) and b of which measure 200 and 300 mm respectively. Additionally introduced into layers B and C is also what is known as a CBS, a ceramic binder system. The seal against the water-carrying layer of earth 22 is ensured by the sealing layers A to C even if the plastic film 26 lying thereabove is destroyed, since said layers A to C are absolutely impermeable to water. This also applies in respect of the rising path of the water-carrying earth 22 to the trough interior 18. The waste material 24 is introduced in a dewatered and stabilized or immobilized state. In order to let off any seepage water therefrom, the trough 12 is designed with an incline of 3%. The water can thereby be collected and removed from the trough interior 18 via seepage water lines (not shown).

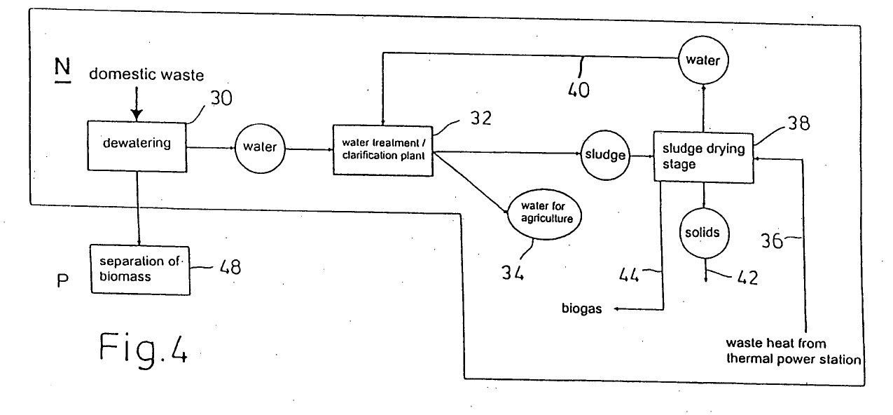

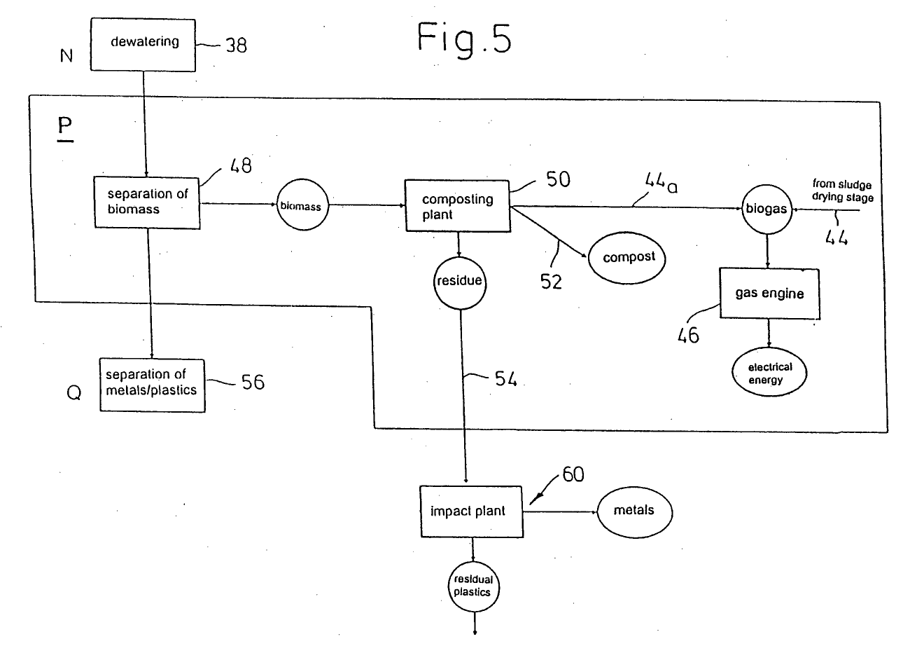

As shown in FIG. 3, the covering 20 of the waste disposal site 10 likewise has three sealing layers A, B, C, on which there lies a seepage layer D having a thickness b of 300 mm with drainage 28 for dissipating rainwater. This seepage layer D bears a humus layer E having a thickness b of 300 mm, which humus layer serves for landscaping the area. In order to give the humus something to hold onto, that is to say to stop it from washing away on account of rainfall and surface water, a thin slurry layer F having a small thickness c of 10 mm is applied thereto as erosion protection.

Waste that is deposited in the waste disposal site 10 is bound beforehand by adding mineral components. The harmful substances it contains are immobilized by adding special additives. By virtue of this treatment of the waste, its intrinsic binding forces are activated, and this leads to irreversible agglomeration of the mineral components contained therein.

Daily domestic waste is separated in a multistage separating plant. In the process, various contents thereof are removed or separated. The residual waste which is left over is processed to form a high-energy fuel which is converted into electrical energy in a thermal power station.

For the sake of better clarity, the method steps for the main fractions generated in the process as so-called output will be presented to start with:

N: water, which following a purification process (water treatment) can be used as service water in agriculture or industry.

P: biomass/compost, which is processed in a composting plant to form high-quality manure or soil improver; resulting biogas can be used to produce energy.

Q: various metals, such as Al, Fe, Cu metals, etc., which are separated in a dry-mechanical process (impact method) and made available to the metal-working industry; various plastics, which are separated into types by means of identification systems, process in regranulation/extrusion plants to form finished products and then sold to industry.

R: residual waste fractions, which can be used in a thermal power station as a fuel substitute in order to make use of the calorific potential; besides electrical energy, thermal energy is also produced which is used both to dry the sludge from the wastewater treatment and also to assist the mechanical dewatering process. The resulting ash from the process is used as raw material to produce CBS, a cement-like binder system produced from the mineral substances of the residual waste fraction.

S: remaining residues are immobilized and introduced into an inert substance waste disposal site as stable waste material.

FIG. 4 shows the treatment of domestic waste in a method section N. First of all, the water is removed mechanically from the domestic waste on centrifugal and friction driers 30. The water content is reduced from up to 60% (input) to about 25%, with a relatively large part of the residual water remaining bound in the biomass of the domestic waste.

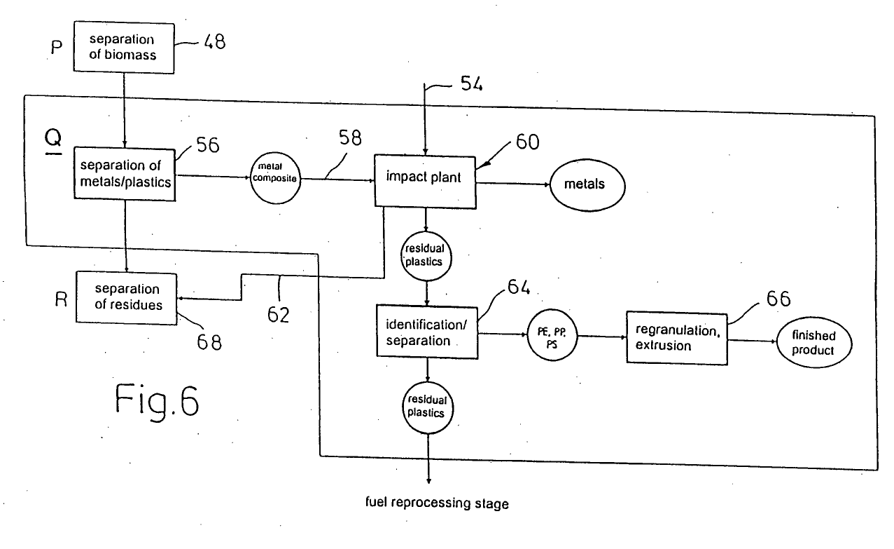

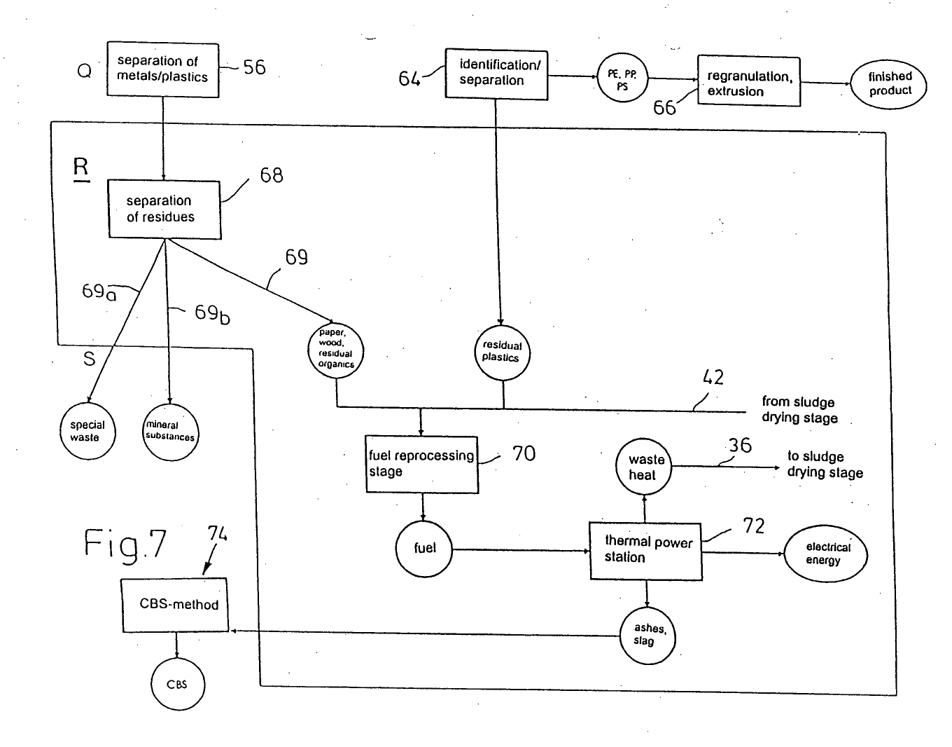

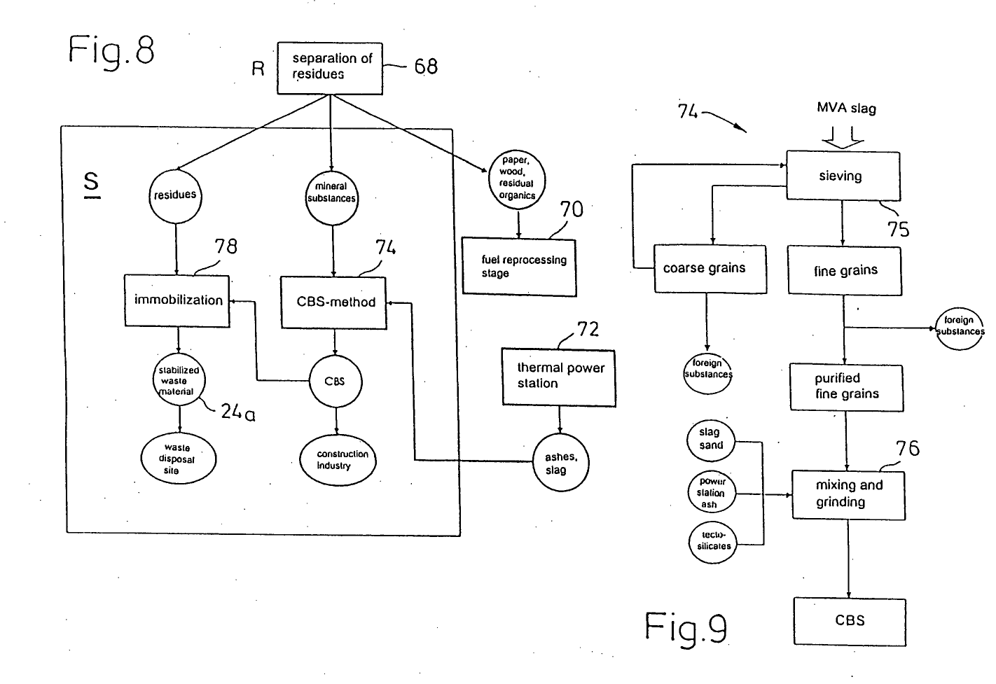

The resulting amount of water is purified in a conventional mechanical-biological clarification plant 32. The separation into sludge and water is achieved by means of the various clarification operations. The resulting clean water is returned to the water cycle, e.g. at 34 to agriculture. The remaining amount of water is removed from the sludge in a sludge drying stage 38—carried out for example by means of waste heat fed in through a line 36 from a thermal power station 72 shown schematically in FIG. 7. This water is then passed back to the clarification plant 32 via a line 40 and purified, and the dried sludge/solids are passed to a fuel reprocessing stage at 42. Biogas produced during the sludge drying operation passes through a line 44 to a gas engine 46 shown in FIG. 5, by virtue of which electric energy is produced therefrom.

In a second step, the biomass is removed from the dried domestic waste—in method section P. For this purpose, all the waste is passed into a separating plant 48. By means of various dry-mechanical separating principles such as sorting, separation of the heavy fractions, sieving and the like, the biomass removed from the domestic waste can be passed to a composting plant 50. There, the substance present is converted in a reactor into compost and biogas. The biogas obtained during the separation process is used, via a line 44a, for electrical energy and heat. The compost discharged through a line 52 is used in agriculture and gardening, and residues pass through a line 54 to a so-called impact plant 60.

In a third method section Q, the metals and plastics are removed from the residual waste—coming from the separating plant 48 for the biomass—in a further separating station 56; using a separation method, the substances can be separated into the desired fractions, as explained below. The metal and plastic fractions pass to a dry-mechanical method. Here, firstly the iron metals are removed via a line 58. The separation of the remaining metals and plastic takes place after line 58 in said impact plant 60 in the so-called impact method. By the sending out of pulses and sudden stopping (pulse interruption) and also high-frequency reflections of the particles, their physical differences are used for separation purposes. The subsequent sieving and separation allows separation into metals and plastics. The metals can be put to further use; in particular, aluminium is used in the aluminium industry.

The plastics pass to an identification device/separation system 64. The plastics separated here, such as polyethylene (PE), polypropylene (PP), polystyrene (PS) and the like, are processed in a station 66 for regranulation and extrusion to form a finished product. The residual plastics are fed to the fuel reprocessing stage as a high-energy component. Reference 62 designates a residual discharge from the impact plant 60, which connects the latter to a residue separation stage 68.

The residues still present essentially consist of minerals, paper, wood, residual organics and waste material. The latter is discharged through a line 69a in method section R; line 69b carries away the mineral substances. Together with the residual plastics from the metal and plastic separation stage 56, paper, wood and residual organics pass through a line 69 to a fuel reprocessing stage 70. The resulting fuel is used by a thermal power station 72 as a supply of energy. The electrical energy produced is fed into the mains supply. The waste heat is—as mentioned—made available to the sludge drying stage as a heat source via the heat line 36. The resulting ash and slag is used to produce the abovementioned ceramic binder system in a CBS production plant 74.

Said CBS, that is to say—as mentioned above—a cement-like binder—is produced from the mineral aggregates of the residue separation stage 68 and from the ashes resulting from thermal processing, mineral waste products above all being removed from said binder system. Said binder system is primarily used in the construction industry.

The resulting waste material 24 must likewise be sanitized, and this is carried out by means of a special immobilization method in station 78 of method section S. Consolid and CBS are used for this purpose. The stabilized waste material 24a is then protected from external environmental influences—such as water for example—and can finally be placed on a waste disposal site without any risk.

FIG. 9 relates to the production of the abovementioned ceramic binder system CBS. The method shown here requires raw materials which result from the incineration of domestic waste, coal or during the processing of metal ores. This slag is the basis for the cement-like binder CBS, which can be used as a high-quality substitute for cement with a considerably reduced cost. Removed from the so-called MVA slag are foreign substances such as metal, paper and plastic, and these can then be fed back to the valuable substance cycle. The residues are mixed with additives—slag sand, power station ash, tectosilicates, clay minerals—and conditioned. The MVA slag is firstly sieved in a station 75, and the fines are purified and fed to a mill or grinder 76 in which they are mixed with slag sand, power station ash and tectosilicates.

The CBS allows valuable use of the MVA slag, and therefore no waste disposal charges are incurred in this respect. Overall, the economic effect on the production costs of a ton of this binder is very high, since the raw material (the slag) is obtainable upon an additional payment and can be separated in a mechanical method from other materials—such as heavy metals for example—and finally converted into the binder CBS using a relatively small amount of energy.

The concrete produced with CBS has a compressive strength of up to 25% more and an expansion of up to 50% less. Hardly any cracks thus occur. The production process per se is relatively simple and thus cost-effective. This all leads to a cost saving of up to 30% compared to conventional Portland cement.

Since the slag is no longer disposed of but rather can be advantageously used as a raw material, there is a great ecological benefit. Since the material has already been incinerated in the previous processes, the energy required to produce this material is very low. The natural resources, which are conventionally used to produce cement, are thus looked after.

The stabilization or immobilization of soils or other mixtures has always been a great problem. This could only be solved at high cost and in an unsatisfactory manner. In most cases, stabilization using conventional methods is only effective in the short term. Furthermore, ecological problems often arise which can adversely affect not only the soil but also the groundwater.

The chemical products used as binders can meet the stabilization requirements only to a limited extent in heterogeneous soils. Earth materials change continuously in terms of their chemical-mineral and also physical composition. This has to date made successful, sustainable stabilization much more difficult or even prevented it altogether. Heterogeneous structures, as in earth and soil, require alternative products for stabilization and immobilization. The CBS Consolid method is this alternative. It is now possible, therefore, using CBS Consolid, to bind and sustainably compact earth, soil, dust and other heterogeneous products.

Comparisons between untreated samples and samples treated with CBS Consolid show considerably differences in the microstructure and properties of the soil or other materials. By virtue of the treatment with CBS Consolid, the capillary rise and thus the sensitivity to water of the soil is considerably reduced.

Consolid consists of predominantly organic substances and also of two phases, namely the liquid phase Consolid⁴⁴⁴ (or C444) and a solid phase Solidry. The liquid phase is a mixture of monomolecular and polymolecular surface-active substances, solubilizers, emulsifiers and catalysts having a content of propylenediamine, dimethyl ammonium chloride and isopropyl alcohol (IPA) and also having the following physical, chemical and safety-related properties, which are essential to the invention:

Appearance:

| | |
|---|---|
| Form: | liquid |
| Colour: | yellow-brown |
| Odour: | IPA |
| Change of state: | solidification/melting point: 40-45° C. |
| Density (at 20° C.): | 0.850 g/cm³ |
| Viscosity (at 50° C.): | approx. 10 cP |
| Solubility in water | dispersible/miscible 450 g/l |
| (40° C.): | |
| pH value (1 g/lH₂O): | 5.5 to 6.5 |
| Flash point: | >40° C. |
| Ignition temperature: | >300° C. |
| Explosibility limits: | lower: 2% by volume |
| | upper: 13% by volume for IPA |
| | (pure) in air. |

The solid—pulverulent—phase consists as Solidry of more than 96% very fine-grained commercially available cement and calcium hydroxide and also 4% of organic component and has the following physical and chemical properties, which are essential to the invention:

Appearance:

| | |
|---|---|
| Form: | solid |
| Colour: | yellowish |
| Odour: | amine |
| Change of physical | 50 to 52° C. |
| state: | |
| melting point/melting | |
| range: | |
| Density (75° C.): | 0.858 g/cm³ |
| Viscosity (75° C.): | <100 mPa |
| Solubility in water | insoluble |
| (20° C.): | |
| in isopropanol (55° C.): | 50 g/l |
| pH value (50 g/lH₂O, | 9 to 10 IPA/water |
| 50° C.): | |
| Flash point: | >170° C. |

This organic component is a paraffin-like mixture of monomolecular and polymolecular surface-active substances having a certain content of alkylamines and dimethyl ammonium chloride, polyacrylates and reactants.

The basic knowledge about the mode of action of the Consolid system leads to the understanding that Consolid acts in a surface-active manner in the pore and micropore range of the soil, dissolves the contact moisture film, thereby leading primarily to an irreversible agglomeration of the fine and very fine particles of the treated soil, and causes high compactibility of the soil via the activation of the intrinsic binding forces of the soil—increasing the cohesion and the internal angle of friction (Giurgea et al., 1998).

The active substance Solidry is produced by acting mechanically, in a ball mill or impact mixer, on a hydraulic binder such as CBS or cement, this leading to the cement or calcium hydroxide particles being completely coated by a paraffin-like component. The dry product Solidry deters water and leads to water sensitivity of the soil and reinforces the intrinsic binding of the soil (cohesion, strength). At the same time, by virtue of the swelling behaviour of the active substances, it prevents the surface water from penetrating into the capillaries of the soil and, together with Consolid⁴⁴⁴®, reduces the capillary rise of the water in the soil. These solids can thus mainly be seen as a “filling” with a pronounced synergetic effect in relation to the capillary fringe of the soil (Merkler et al., 1996; Giurgea et al., 1998).

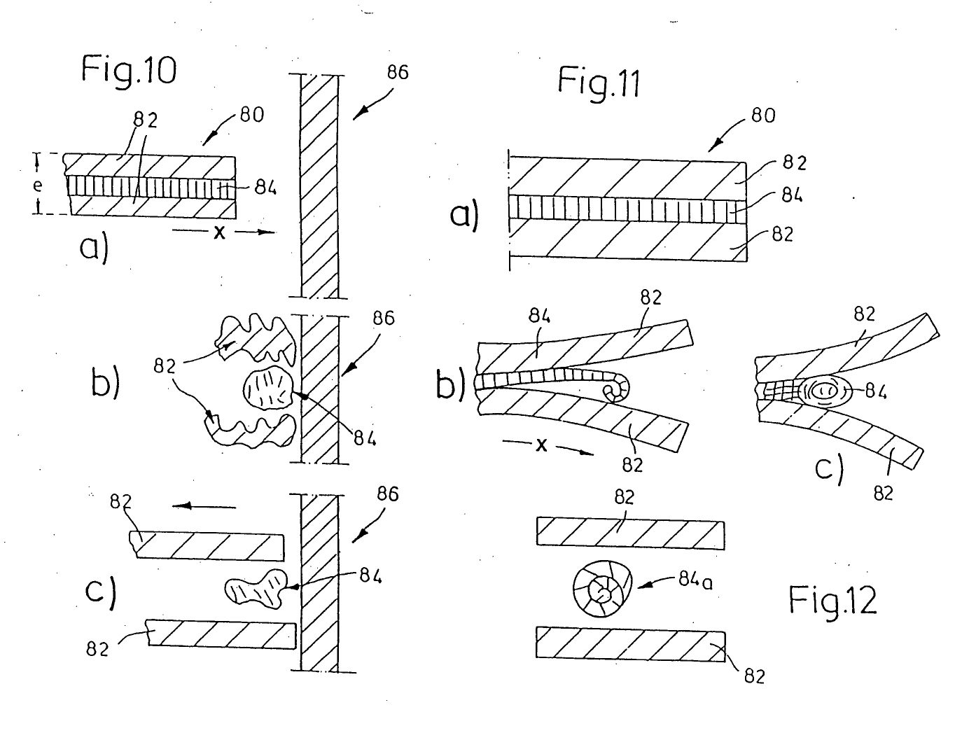

FIGS. 10 to 14 show the separation of composite materials in the region of the impact plant 60. A composite strip 80 of thickness e comprising a central layer 84 of an aluminium alloy which is covered on both sides by PE layers 82 is passed in the conveying direction x to an impact wall 86 which crosses the latter (FIG. 10). By virtue of this pulse of acceleration and sudden interruption to this pulse at the impact wall 86 and the shockwaves which occur between the layers 82, 84 of the composite strip 80, the physical differences of the various materials—such as density, elasticity, ductility or the like—are exploited such that, on account of the different behaviour of the constituents 82, 84 of the composite strip 80, said constituents separate from one another.

By means of the impact on the impact wall 86, materials which tend to deform—for example the aluminium layer 84—are deformed whereas elastic materials—that is to say the two plastic layers 82—absorb the impact energy, with the result that these PE layers 82 do not undergo any—or undergo only a slight—change in terms of their structure. Specifically, if a composite material 80 is subjected to such a treatment, the metal layer 84 is deformed whereas the plastic layers 82, following a brief deformation, change back to their original state on account of the return force. This different behaviour of the composite materials 82, 84 results in a shearing force being produced between them which separates the layers 82, 84 along their phase limits. In mixtures, no separation occurs; however, the materials present in the mixture also take on different structures on account of the physical differences. For instance, different characteristic structures of the materials are produced—depending on the abovementioned physical properties.

Step b) in FIG. 10 shows the considerably and permanent deformation of the aluminium layer 84 and also the very brief deformation of the two plastic layers 82; a shearing force is produced at the phase limits between the materials of the layers 82, 84.

In step c) of FIG. 10 both the aluminium layer 84—now of spherical shape—and the plastic layers 82 rebound counter to the pulse direction x, which plastic layers have stretched back out of the deformation situation of step b) as a result of the return force. Metals are deformed and as a result take on a spherical structure which results from a rolled-up metal layer 84; these spheres 84a now have a much greater diameter than previously in the flat structure prior to treatment.

The described changes are shown in FIGS. 11, 12. Step a) of FIG. 11 shows the starting product 80 with its strip-like layers 82, 84. A separation in progress can be seen in b); the layers 82 open up from one another like a mouth, and the central Al layer 84 starts to roll up like a tongue counter to the pulse direction x. In step c), the central layer 84 increasingly becomes like a sphere and achieves the spherical shape 84a as shown in FIG. 12; the layers 82 have returned to their original shape—as described above.

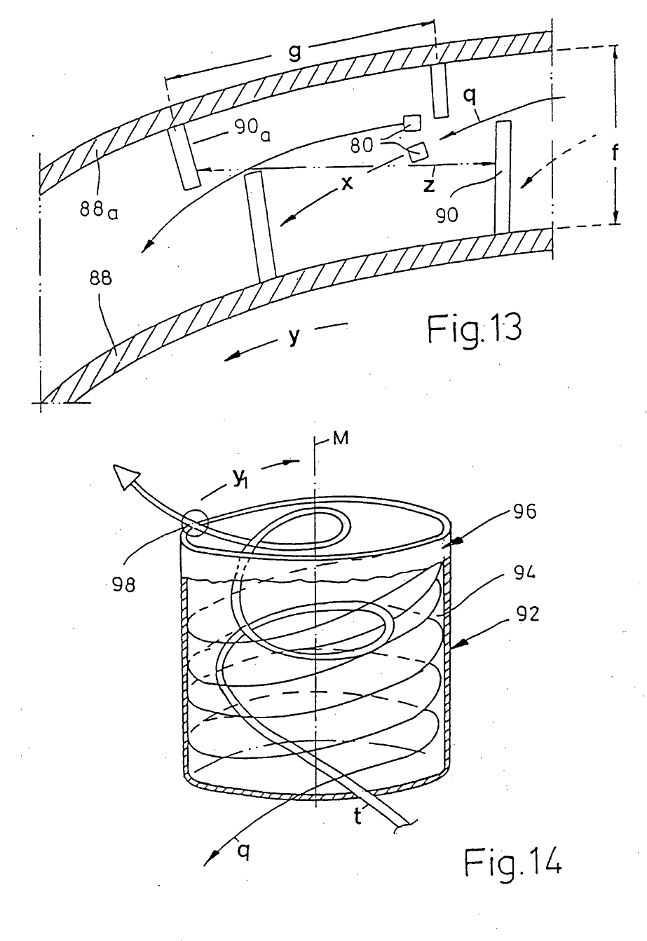

In FIG. 13, impact surfaces 90, 90a which face one another project, at a horizontal distance g from one another, from two wall surfaces 88, 88a that are curved in parallel at a clear radial distance f, wherein one of the wall surfaces 88 rotates relative to the other wall surface 88a in the direction y, and namely in the conveying direction x of the composite materials 80. Reference z designates a line which shows an impact movement of particles.

FIG. 14 shows a rotor 92 with a direction of rotation y₁ about the rotor axis M, to the rotor space 94 of which there is fed a material mixture through a material inlet 96 from above. The composite materials 80 of the material mixture are guided downwards by gravity—the spiral conveying path is shown at q. Process air is introduced from below, the flow path t of which runs counter to said conveying path q. The residence time of the composite materials 80 in the rotor space 94 is affected by the rising air, and easily dispersible particles and dust are entrained in a cyclone and leave the rotor 92 with the process air at an outlet 98.

1. Waste disposal site for storing waste and residues of solid organic or inorganic substances, composites and mixtures thereof,
wherein,
arranged in the ground (22) is a trough (12) comprising a trough bottom (14) and side walls (15), the trough bottom of which contains at least two water-tight layers (B, C) with constituents of a ceramic binder system (CBS).

2. Waste disposal site according to claim 1, wherein arranged flat between the top water-tight layer (C) and the waste material (24, 24a) is at least one water-tight plastic film (26).

3. Waste disposal site according to claim 2, wherein compacted debris is stored as waste material (24a) on the plastic film (26).

4. Waste disposal site according to claim 1, wherein an angle (w) of 90° to 150°, preferably about 130°, between trough bottom (14) and side wall (15).

5. Waste disposal site according to claim 1, wherein the trough bottom (14) is inclined at an angle of up to about 10° with respect to the horizontal.

6. Waste disposal site according to claim 1, wherein a covering (20) which contains at least two water-tight layers (B, C) on which there is arranged at least one seepage layer (D) for dissipating rainwater.

7. Waste disposal site according to claim 6, wherein the seepage layer (D) is provided with drainage (28).

8. Waste disposal site according to claim 6, wherein the seepage layer (D) is superposed by a humus layer (E) which possibly bears a thin slurry layer (F) as erosion protection.

9. Waste disposal site according to claim 1, wherein an inorganic binder, provided in the water-tight layers (B, C), for hydraulic setting compounds in which substances containing silica, alumina, iron oxides and/or lime are mixed, ground and burned until they are sintered.

10. Waste disposal site according to claim 9, wherein the binder system comprises a liquid phase and a solid phase, the latter consisting of very fine-grained hydraulic binder and calcium hydroxide and also up to 10%, preferably about 4%, of organic component.

11. Waste disposal site according to claim 10, wherein the liquid phase is a mixture of monomolecular and polymolecular surface-active substances, solubilizers, emulsifiers and catalysts having a content of propylenediamine, dimenthyl ammonium chloride and isopropyl alcohol.

12. Waste disposal site according to claim 1, wherein an irreversible agglomeration of the fine and very fine particles of the treated layer is produced by means of the ceramic binder system, with a high degree of compacting of the bottom fraction associated with the binder system.

13. Waste disposal site according to claim 2, wherein the waste (24, 24a) or other such substances stored in an interior (18) thereof are bound by adding mineral components, in particular by means of the ceramic binder system (CBS).

14. (canceled)

15. Method of treating waste and residues of solid organic or inorganic substances, composites and mixtures thereof, in particular fractions of a waste disposal site according to claim 1, wherein the waste, in particular domestic waste, is dewatered, separated from contained biomass and then a separation of metal/plastics takes place, these being recycled into industrial cycles as secondary raw materials.

16. Method according to claim 15, wherein, prior to introducing the waste into the waste disposal site, said waste is bound by adding mineral components and its intrinsic binding forces are activated.

17. Method according to claim 15, wherein harmful substances in the waste are immobilized.

18. Method according to any of claims 15, wherein a separation of residues, following which separated-out mineral substances and/or specially fed-in slag or ashes are processed to form a ceramic binder.

19. Method according to claim 15, wherein the main fraction produced as this is carried out, in the form of:
water;
biomass/compost/biogas;
metals such as Al, Fe, Cu metals or the like;
residual waste fractions;
residues.

20. Method according to claim 19, wherein mineral substances from the residual waste fraction and/or from the residues and/or from the ultimately produced ash are used as raw material to produce the binder (CBS).

21. Method according to claim 20, wherein slag is sieved off and is mixed with slag sand and/or power station ash and/or tectosilicates during a comminution operation.

22. Method according to claim 21, wherein in the composite or mixture the constituents are broken down or split by means of a pulse using a device which suddenly interrupts the flow of said composite or mixture.

23. Method according to claim 22, wherein process air is fed in, in a rising flow path, in the opposite direction to the conveying path generated downwards in a spiral-like manner in a rotor (26) with a vertical axis.

24. Method according to claim 23, wherein a shockwave is generated on an impact wall of the rotor between the layers of the composite.

25. Method according to claim 23, wherein two wall surfaces arranged coaxially and at a radial distance to one another rotate relative to one another about their axis and the composites or mixtures moved by centrifugal forces are moved and broken down between impact surfaces projecting from the impact walls.

26. Method according to 25, wherein the composite (10) is broken down when it collides with an impact wall (20) and its metal constituents are shaped into spheres, wherein possibly the layered metal constituent is rolled up during the shaping operation.

27. Method according to claim 26, wherein the composite is subjected to a prior heat treatment before the splitting or breakdown operation, wherein possibly the discharge from the splitting or breakdown operation is subjected to a separation and/or sieving operation and/or to a cracking-off operation for non-iron metals.

28. Method according to claim 15, wherein the metal and/or plastic parts are compacted following separation and possibly extruded following separation.

29. Method according to claim 15, wherein the plastics are separated from one another by turbolaminar separation and/or identification.

30. (canceled)

31. Apparatus for carrying out the method according to claim 22, wherein the conveying path (q) for the composites (82) or the mixture is fed into the interior (94) of a rotor (92) in the opposite direction to that of the flow path (t) of process air.

32. Apparatus according to claim 31, wherein the material supply (96) is arranged in the ridge region of the rotor (92)

33. Apparatus according to claim 32, wherein the conveying path (t) runs between two wall surfaces (90, 90a) that can be moved relative to and at a distance (g) from one another, from which wall surfaces impact surfaces (90, 90a) that are offset with respect to one another project on either side into the conveying path.

34. Apparatus according to claim 33, wherein the wall surfaces (90, 90a) are coaxially curved.

35. Apparatus according to claim 33, wherein the wall surfaces (90, 90a) are mounted such that they can rotate in the rotation direction (y₁) of the rotor (92).

36. Apparatus according to 35, wherein at least one further feature disclosed in the description and/or drawing.
